(19) United States
(12) Patent Application Publication
(10) Pub. No.: US 2024/0403579 A1
(43) Pub. Date: Dec. 5, 2024

(54) USING RFID FUNCTIONS AS A BASIS FOR OBJECT PEDIGREE AUTHENTICATION AND SOCIAL MEDIA INTERACTION REGARDING THE OBJECT

(71) Applicant: Robert Rask, Orem, UT (US)

(72) Inventor: Robert Rask, Orem, UT (US)

(21) Appl. No.: 18/732,480

(22) Filed: Jun. 3, 2024

Related U.S. Application Data
(60) Provisional application No. 63/505,993, filed on Jun. 2, 2023.

(51) Int. Cl. G06K 7/10; G06F 21/44; G06F 21/88

(52) U.S. Cl. CPC G06K 7/10366; G06F 21/44; G06F 21/88

(57) ABSTRACT

The present invention is a system and method for creating an electronic system for tracking and managing the ownership and use of an object, wherein an RFID chip is embedded into an object, such as a musical instrument, wherein an application on a mobile device with NFC chip reading technology enables the mobile device to scan the RFID chip and launch an application that accesses a cloud-based database, the database storing information regarding the device such as pedigree and past ownership, wherein a user may post pictures, videos or commentary regarding the object, wherein the RFID chip may also be used as an anti-theft device allowing any nearby mobile device to establish contact with the RFID chip and transmit a location to the database when activated, and wherein the application allows users to “follow” the device and make social media posts.

### BACKGROUND

### Field of the Invention

This invention relates generally to radio frequency identification (RFID). More specifically, the present invention utilizes an embedded RFID chip to provide access to a database of information regarding a particular product, wherein the RFID technology is linked to information that is not typically associated with RFID tracking technology.

### Description of Related Art

RFID technology allows information to be transmitted wirelessly between a small electronic device called an RFID chip and a reader device. The reader device may be a dedicated tracking device or a multipurpose device, such as a tablet or mobile phone. The RFID chip contains a small antenna and microchip that stores information. When the chip comes into range of a reader device, it wirelessly transmits the stored information to the reader using radio waves.

The process of transmitting information between the RFID chip and the reader is known as RFID communication. There are two types of RFID chips: passive and active. Passive RFID chips do not have their own power source and rely on the energy from the reader to power their transmissions. In contrast, active RFID chips have their own power source and can transmit information over greater distances than passive chips.

When a reader device sends out a radio signal, the passive RFID chip receives the energy from the signal and uses it to power up the RFID chip's microchip. The chip then sends out a radio signal containing its unique identification number or other stored information. In the past, the reader device received this signal and used it to identify and track the location of the chip.

Active RFID chips, on the other hand, have their own power source and can transmit information over greater distances than passive chips. When a reader device transmits a radio signal, the active RFID chip receives the signal and uses its own power source to transmit a response signal back to the reader. This allows the chip to be located over greater distances than passive chips and in areas where radio signals are weak.

RFID technology is used in a wide range of applications, including inventory tracking in warehouses, identifying pets and livestock, monitoring patients in hospitals, and even in contactless payment systems. For example, in a warehouse, RFID chips can be attached to inventory items, allowing the items to be tracked and monitored as they move through the warehouse. This can help to reduce inventory errors and improve the efficiency of the warehouse operation.

Accordingly, it would be an advantage over the prior art to use RFID technology to provide information that has not typically been associated with just the tracking of objects. It would be a further advantage to use either passive or active RFID technology to provide the new functionality.

Another topic that is related to the present invention is that of memorabilia. More specifically, authentication of memorabilia is a very difficult task. Authenticating memorabilia, such as sports memorabilia or historical artifacts, can be a challenging task because of the potential for fraud and forgery. There are several problems associated with authenticating memorabilia, including:

Lack of documentation: In many cases, there may be a lack of documentation or records to prove the authenticity of the memorabilia. This can be especially true for older items that have been lost or damaged over time.

Counterfeiting: Counterfeiters can create fake memorabilia that closely resembles the original, making it difficult to distinguish between the two. For example, a fake autographed baseball may look very similar to a real autographed baseball, making it difficult for collectors to know if they are purchasing a genuine item.

Alterations: Some collectors or dealers may alter memorabilia in an attempt to increase its value. For example, a dealer may add an autograph to a jersey or baseball bat to make it appear more valuable, even though the autograph is not genuine.

Lack of expertise: Authenticating memorabilia requires specialized knowledge and expertise. For example, an expert in autographs may be able to authenticate a signature on a baseball but may not be able to authenticate other types of memorabilia.

High demand: High demand for certain types of memorabilia can drive up prices, leading to an increase in fraud and forgery. Collectors may be willing to pay large sums of money for rare or highly sought-after items, making it more attractive for counterfeiters to create fake memorabilia.

Overall, authenticating memorabilia can be a complex and challenging task. Collectors and dealers should be aware of the potential problems associated with authenticating memorabilia and take steps to verify the authenticity of items before making a purchase.

Accordingly, it would be an advantage over the prior art to provide a new system and method for the tracking of memorabilia.

It would be a further advantage if the new system and method allowed non-owners to become more invested in memorabilia or other items of value by using social media and other platforms on the Internet to encourage interest in and following of the memorabilia.

Another topic that is related to the present invention is that of NFTs. NFTs, or non-fungible tokens, are digital assets that are being used to represent items of value in a variety of ways. Overall, NFTs are being used to represent a wide range of items of value in a digital format, allowing for easier transfer and proof of ownership. The blockchain-based system provides a secure and transparent way to track ownership and ensure authenticity, which is particularly important for items of high value.

NFTs are typically associated with high value assets in the following ways:

Art and Collectibles: NFTs are being used to represent unique pieces of digital art or collectibles, such as a one-of-a-kind digital painting or a rare in-game item. The NFT allows the owner to prove ownership and authenticity of the item.

Sports Memorabilia: NFTs are being used to represent unique sports memorabilia, such as a digital version of a game-winning jersey or a collectible trading card. The NFT allows the owner to prove ownership and authenticity of the item, as well as trade or sell it on a blockchain-based marketplace.

Music and Entertainment: NFTs are being used to represent ownership rights to music or other forms of entertainment, such as a ticket to a concert or an exclusive backstage pass. The NFT allows the owner to prove ownership and allow others to experience exclusive content regarding the NFT.

It would be an advantage over the prior art to provide a means for bringing RFID tracking and security, memorabilia authentication or pedigree, social media, and NFTs together in a new and fundamentally different way than they have been used in the past.

### BRIEF SUMMARY

The present invention is a system and method for embedding an RFID chip into an item, wherein the RFID chip is read by a mobile device with NFC chip reading technology, wherein the mobile device provides access to a cloud-based or online database to identify the RFID chip and then access data in the database that is associated with the RFID chip, wherein an application on the database stores information regarding the item such as pedigree and past ownership, wherein a user may post pictures, videos, and commentary regarding the item, and wherein the RFID chip may also be used as a security feature allowing any nearby mobile device to establish contact with the RFID chip and broadcast a location when activated.

In a first aspect of the invention, the RFID chip is a passive device that is embedded into an item, and wherein the RFID chip is powered by a signal from a reader that enables the RFID chip to transmit identification data.

In a second aspect of the invention, the mobile device includes an NFC reader to provide power to the RFID chip.

In a third aspect of the invention, the mobile device executes an application that provides access to the cloud-based database that stores information regarding the item.

In a fourth aspect of the invention, the application on the mobile device may be integrated with social media accounts to enable items in the database to be followed, liked, visited, commented on, and so forth.

In a fifth aspect of the invention, NFTs may be integrated with the items in the database to expand access to and commercialization of the items.

In a sixth aspect of the invention, RFIDs installed in items may be used to authenticate items that are listed in the database, and thereby improve efforts to authenticate valuable items including memorabilia, musical instruments, etc.

In a seventh aspect of the invention, the RFID chip may still be used as a security device wherein a plurality of mobile devices near the item may assist in security for the item having the RFID chip installed therein because of the large number of mobile devices that may provide location tracking.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram showing an object and an embedded RFID chip.

FIGS. 2A and 2B show a frontside and backside of a guitar.

FIG. 3 is a block diagram showing interaction of the elements of the invention.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

At the most fundamental level, the purpose of the embodiments of the invention is to allow a more intimate interaction with an object, those interested in the object, and sometimes with the owners of the object. The objects in questions are anything that has inherent value (such as a musical instrument), or objects that obtain value because of what they are, who uses them, who owns them, how they are used, where they are used, and why they are used. This definition is intended to be broad and all-encompassing because there are so many different objects that may fall within the scope of the embodiments. Indeed, it is likely that there are objects or categories of objects that are not yet known but will also fall within the scope of the embodiments of the invention.

However, when trying to understand the purpose of the invention, it is useful to name a few of the types of objects that fall within the scope of the claims. The first type of object is memorabilia. Memorabilia may be objects that are kept or collected because of their historical interest, especially those associated with memorable people or events. Memorabilia or collectibles may be created to commemorate a person, a place or an event such as trading cards, medallions, plaques, pictures, etc. Other memorabilia may be ordinary items, but they were used by a particular person or were present at a particular event.

The second type of object is one that is valuable because of what it is. Such objects may also have value because of who uses them, or they were present at a particular event, but they typically have value in and of themselves. These objects include items used in the entertainment industry such as musical instruments, clothing, costumes, purses, fashion accessories, equipment (which can be almost anything), etc. These objects should also be considered to include sporting items that are used in games. Sporting items might be baseballs, basketballs, hockey sticks, but also baseball gloves, cleats, shoes, jerseys, etc.

What may be apparent from the descriptions above is that items may have value for many different reasons, and often for more than one reason. None of these reasons should preclude them from being within the scope of the embodiments to be described hereinafter.

It may be useful to walk through the embodiments of the invention by selecting a particular object and explaining how the embodiments may be used. However, it should be understood that the examples given should in no way limit the embodiments if not every embodiment of the invention is applicable to the object selected.

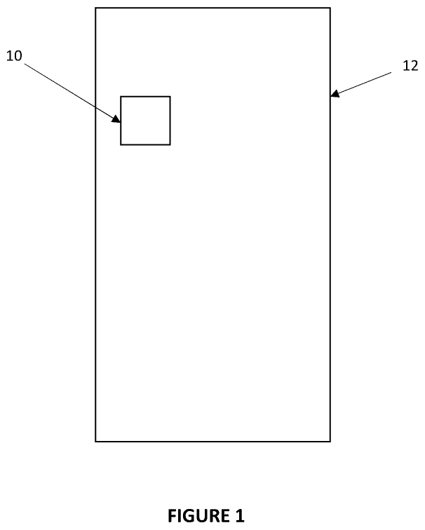

FIG. 1 shows that the embodiments of the invention include two particular aspects that are important to the overall subject matter of the invention. The first aspect is the application of RFID technology. In the first embodiment of the invention, an RFID chip 10 is shown as disposed within or on a selected object 12.

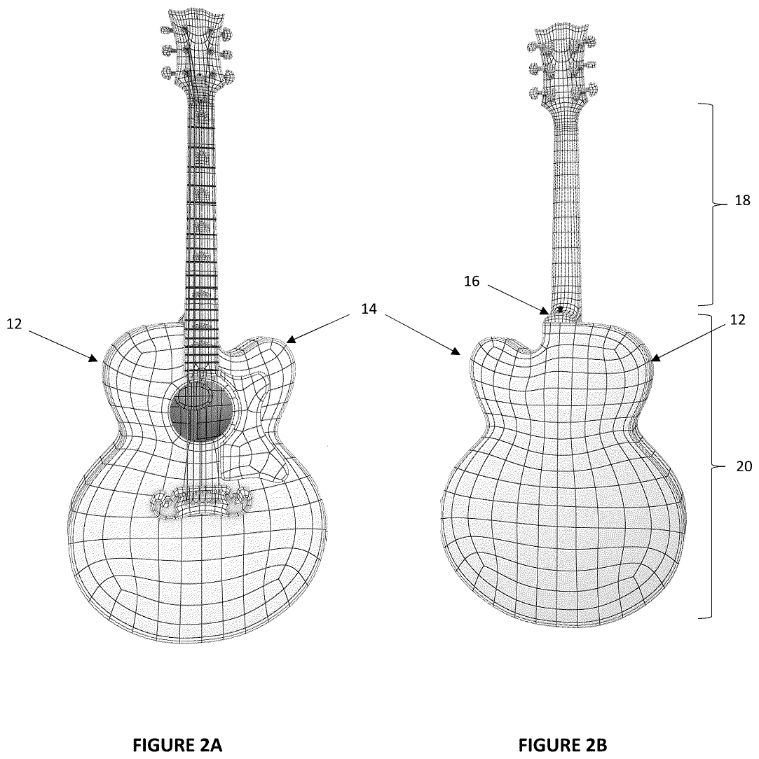

FIG. 2 shows that in this first embodiment, the selected object 12 is a guitar 14. The nature of the guitar is not relevant to the embodiments. Thus, the guitar 14 may be any type of guitar such as acoustic, electric, etc. However, the guitar 14, for whatever reason, has value. This value may be an intrinsic value because it is well made, it is historical, it was present at a certain event or events, it was created by, used by, or owned by a particular person, or some combination of any of these or other attributes. The source of the value is not important to the embodiments. What is important is that the guitar 14 has value.

In the guitar 14, the RFID chip 10 might be disposed within a heel 16 of the guitar 14, wherein the heel may be defined as the location where a neck 18 is attached to the body 20 of the guitar. It should be understood that the RFID chip 10 may be disposed anywhere on or within the guitar 14. However, the heel 16 provides a convenient location where the RFID chip 10 will not be visible and will not be able to be easily removed. Furthermore, the wooden materials of the guitar 14 should not substantially interfere with the operation of the RFID chip 10. Namely, the RFID chip 10 may be inserted into a hole in the heel 16. The hole may then be sealed to prevent tampering with the RFID chip 10. For example, the hole may be sealed with a matching wood already being used for the heel 16, or any other preferred method.

Furthermore, when an NFC reader is brought close enough to the RFID chip 10, the wood and other materials in the guitar 14 may not substantially interfere with radio signals between the RFID chip 10 and the NFC reader. The RFID chip 10 may be a passive or active device as described earlier.

So far, the use of an RFID chip 10 is not different than any other use of the technology, in that the RFID chip 10 may be used to track the location of the guitar 14.

However, a first important aspect of the invention is what is done with the unique identifier that is obtained from the RFID chip 10.

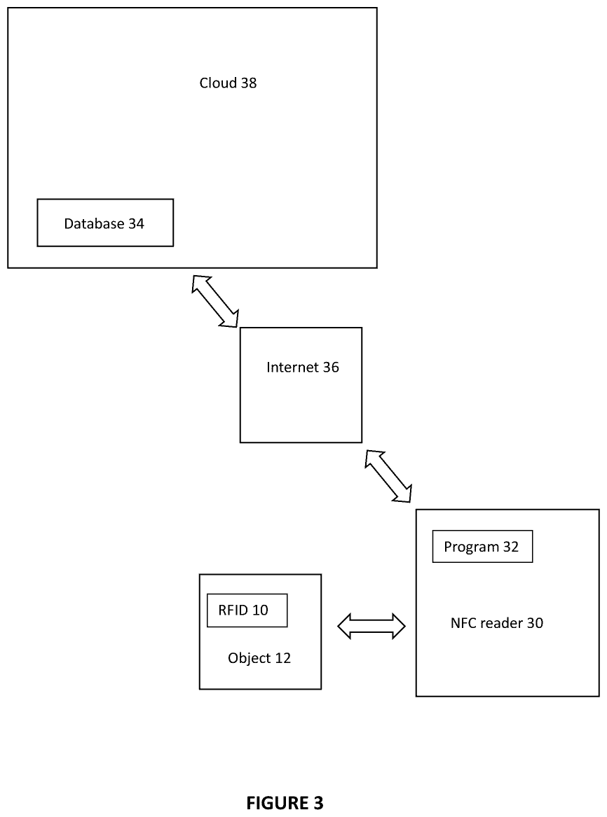

FIG. 3 shows that the NFC reader 30 executes a program 32 that reads the unique identifier of the RFID chip 10 from the object 12 and then accesses through the Internet 36 or other network a database 34 that is stored online or in the Cloud 38. The online or cloud-based database 34 (hereinafter to be referred to only as “the database 34”) is a database accessible from a local network or the Internet 36, as opposed to one that is stored locally on an individual computer or its attached storage (such as a CD or thumb drive). The database 34 may be hosted on websites or made available as software as a service product accessible via a web browser. The database 34 may be free or require payment to access, such as by a monthly or yearly subscription.

The program 32 that accesses the database 34 may be a self-contained and standalone executable, or it may be a browser-based application that runs on a browser on a computing device. The computing device may be a desktop type of computing device, or it may be a mobile device such as a mobile telephone or a tablet computer.

The database 34 may be any database that may be accessed by the program 32 described above, wherein the program may be running on a computing device having a wired or wireless connection to a network such as the Internet 36. It is important that the database 34 be accessible by any device having a wired or wireless connection to the Internet 36. Thus, a hardwired ethernet connection or a cellular wireless connection are both sufficient to access the database 34.

The database 34 is a critical element of all of the embodiments of the invention because it enables the unique identifier to be used not only to identify the object 12, but to bring new functionality that is lacking for objects of value.

The functions of the database 34 may include, but should not be considered as limited to, 1) providing authentication data for the guitar 14, 2) providing updated tracking information by logging a current location of the guitar, 3) enabling the user to upload pictures, videos, or commentary regarding the guitar, 4) enabling the user to access previously uploaded pictures, videos, commentary, and tracking information regarding the guitar, 5) enable the user to follow an account that provides tracking, pictures, videos and commentary regarding the guitar, and 6) send content to or receive content from a social media account from the database.

Thus, the database 34 may function as more than just a repository of data regarding the guitar 14. The database 34 may function as a social media account, and it may interact with users and with other social media accounts, sharing information with them and receiving information from them.

A first example of an interaction with a user of the database 34 is to use the program 32 to search for an account associated with the guitar 14. Once the account is located, a user may access the account and find a menu of information that is stored regarding the guitar 14. This information may include learning at what concerts that the guitar 14 has been played, what artists have played the guitar, and how, when, where and by whom the guitar was manufactured. The information may include pictures or videos showing the construction of the guitar 14. The database 34 may show a chain of custody and provide a list of all of the previous and current owners. The database 34 may display all the locations at which the RFID chip 10 was scanned, or a chronological list of all of the concerts or locations where the guitar 14 was played. The database 34 may include an interactive forum where users may post messages, ask questions, or answer questions about the guitar 14.

The owner of the guitar 14 may also include a blog or other diary of observations regarding the concerts, the use of the guitar, and interactions with fans.

The list above of what may be done with the contents of the database 34 should not be considered as exhaustive but simply indicative of the types of interactions that may take place for each object 12 that has a unique RFID chip 10 and for which information is stored therein. The list should be considered as including all of the various social media interactions that may take place on any social media, but also include the unique aspects of the embodiments of the invention that are associated with the tracking and authentication of objects of value that may benefit from the unique characteristics of the invention.

The example above is a list of possible data that may be stored and interactions that may take place when the object of value is a guitar. A different example of the type of data that may be stored may be when the database is used for an object such as an NFT.

Physical NFTs are digital tokens linked to real-world assets and are often used to prove ownership over artworks, property deeds, and other assets. There are usually two components behind physical NFTs, the digital one stored on the blockchain and the physical one that you own. The NFT may be included in the database when the physical asset may or may not have the RFID chip 10 disposed on or within the asset. When the physical object may have an RFID chip 10 embedded on or in the physical object, there is no issue. However, when it is not practical or possible to embed the RFID chip 10, the database may still be used to provide all of the interactions and data storage that is provided for physical objects with the RFID chip.

Accordingly, another aspect of the embodiments of the invention is that the embodiments are not limited to only providing the database for objects that have the RFID chip 10. Thus, the database may have a searchable index so that users may locate objects that might be stored within the database but not have an associated unique identifier from the RFID chip 10.

While it is not a primary objective of the invention to use the RFID chip in an item to provide active security for the item, the large number of mobile devices simply make it likely that the location of the item may be updated often and thereby provide added security for the item by often reporting on the location of the item.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An electronic system for managing an object, comprising:
an RFID chip embedded within the object to be managed, the RFID chip having a unique identifier associated with the object;
a device with chip reading technology for scanning the RFID chip and launching an application;
a database that is stored online, wherein the database includes an index of a plurality of RFID unique identifiers;
the application stored on the mobile device that accesses the database and locates the object in the database using the RFID unique identifier, the database containing information regarding the object; and
a user interface within the application for interacting with the database.

2. The electronic system as defined in claim 1 wherein the device is selected from the group of devices comprised of a mobile device, a mobile telephone, a tablet, and a desktop computer.

3. The electronic system as defined in claim 2 wherein the system is further comprised of an anti-theft system in which the RFID chip is activated upon being read by a chip reader, and wherein the chip reader is used to establish contact with the RFID chip and transmit a location of the object to the database.

4. The electronic system as defined in claim 3 wherein the system is further comprised of a social media component within the application that allows users to follow the object or the artist owner of the object and make social media posts.

5. The electronic system as defined in claim 4 wherein the RFID chip is embedded within the body of the object.

6. The electronic system as defined in claim 5 wherein the RFID chip is passive or active.

7. The electronic system as defined in claim 6 wherein the object is selected from the group of objects comprised of objects of inherent value, objects of non-inherent value, memorabilia, musical instruments, sports equipment, clothing, costumes, fashion accessories, and historical objects.

8. The electronic system as defined in claim 1 wherein the chip reader is a near field communication (NFC) chip reader.

9. The electronic system as defined in claim 1 wherein the application uses the NFC chip reading technology to establish a wireless connection with the RFID chip.

10. The electronic system as defined in claim 1 wherein the database enables authentication of the object.

11. A method for using an electronic system to track, authenticate, and manage interaction with an object, said method comprising:
embedding an RFID chip within the object, the RFID chip having a unique identifier associated with the object;
providing a device with chip reading technology;
scanning the RFID chip and launching an application on the device;
providing a database that is stored online, wherein the database includes an index of a plurality of RFID unique identifiers;
accessing the database using the application stored on the device and locating the object in the database using the RFID unique identifier, the database containing information regarding the object; and
providing a user interface within the application that enables users to interact with the database.

12. The method as defined in claim 11 wherein the method further comprises selecting the device from the group of devices comprised of a mobile device, a mobile telephone, a tablet, and a desktop computer.

13. The method as defined in claim 12 wherein the method further comprises:
activating an anti-theft system in which the RFID chip is activated upon being read by a chip reader; and
transmitting a location of the object to the database once the RFID chip is read by the chip reader.

14. The method as defined in claim 13 wherein the method further comprises:
creating a social media account for the objects listed in the database; and
providing social media features for the objects listed in the database such that enables users to follow the object, follow the owner of the object, and make social media posts regarding the object or the owner.

15. The method as defined in claim 14 wherein the method further comprises embedding the RFID chip within the object.

16. The method as defined in claim 15 wherein the method further comprises embedding an active RFID chip in the object to thereby increase detectability of the object or embedding a passive RFID chip in the object when the active RFID chip is not desired.

17. The method as defined in claim 16 wherein the method further comprises selecting the object from the group of objects comprised of objects of inherent value, objects of non-inherent value, memorabilia, musical instruments, sports equipment, clothing, costumes, fashion accessories, and historical objects.

18. The method as defined in claim 11 wherein the method further comprises using a near field communication (NFC) chip reader as the chip reader.

19. The method as defined in claim 11 wherein the method further comprises establishing a wireless connection with the RFID chip application using the NFC chip reading technology.

20. The method as defined in claim 11 wherein the method further comprises authenticating the object using the database.
